(19) United States
(12) Patent Application Publication
(10) Pub. No.: US 2012/0180631 A1
(43) Pub. Date: Jul. 19, 2012

(54) Projectile resistant matrix for manufacture of light weight projectile resistent trauma shields without metal or ceramic plates

(76) Inventors: Alan R. Sporn, Laguna Hills, CA (US); Gabriel Pilon, Fountain Valley, CA (US)

(21) Appl. No.: 12/583,138

(22) Filed: Aug. 13, 2009

Related U.S. Application Data
(60) Provisional application No. 61/188,952, filed on Aug. 14, 2008.

(51) Int. Cl. F41H 5/04; B32B 37/10

(52) U.S. Cl. 89/36.02; 264/258; 89/904

(57) ABSTRACT

The present invention discloses a method of producing and application for a projectile resistant matrix that allows for manufacture of low weight projectile resistant armor trauma shields without metal or ceramic plates using projectile resistant textiles encapsulated in a composite matrix through use of injection molding process or spray-on technique as constituents of the projectile resistant trauma shield without metal or ceramic plates of the present invention.

### CROSS-REFERENCES TO RELATED APPLICATIONS

The present application claims priority from related U.S. Utility Provisional Patent Application Ser. No. 61/188,952 filed Aug. 14, 2008, the entire disclosure of which application is expressly hereby incorporated by reference herein.

### BACKGROUND OF THE INVENTION

(1) Field of the Invention

The present invention generally relates to projectile resistant matrix and, more particularly to manufacture of projectile resistant armor trauma shields without metal or ceramic plates.

(2) Description of Related Art

Conventional ballistic resistant armor utility trauma plates include metal and ceramic based armor used for both military and civilian use. While metal based armor is effective in stopping most types of rounds, it suffers the disadvantage of being fairly heavy and this property leads to performance degradation, especially in use with personal body armor. While ceramic based armor trauma plates are somewhat effective in stopping various rounds, it has the disadvantages of being brittle and subject to cracking and is much less effective on stopping multiple rounds than the metal based armor trauma shields.

Alternative materials to heavy metals and ceramics are now conventionally employed in ballistic resistant applications. Such materials include various types of fibers (e.g., Dyneema®, Spectra Shield®, Kevlar®), aramid fiber composites, Teflon fiber composites, boron composites, unidirectional fiber composite materials, vulcanized urethane 3000 denier aramid composites. and unidirectional fiber/flexible resin composites. Such materials may generally be cut and fabricated to specification using commonly available tools, however, these materials if used alone are not as effective in stopping multiple ballistic threats.

The U.S. Pat. No. 6,806,212 entitled “Coating and Method for Strengthening a Structure,” which is assigned to the assignee of the present application, and the entire disclosure of which is expressly incorporated by reference herein, discloses a composite coating that is comprised of an elastomeric material having one or more embedded fiber layers. The U.S. Pat. No. 6,806,212 is directed to protection of fixed structures such as walls, rather than armor trauma plates.

Other conventional anti-ballistic trauma plates have been in use for a number of years. Reference is made to the following few exemplary U.S. Pat. Nos. 6,651,543 and 6,532,857. U.S. Pat. No. 6.651,543, entitled “Lightweight Soft Body-Armor Product,” discloses ballistic panels incorporated into a lightweight soft body armor product adapted for covering an area of the body. The ballistic panes includes an assembly of woven fabric plies with warp and fill yarns formed of bundled aramid fibers. Disadvantageously, this disclosed method does not include any use of metal plates. The U.S. Pat. No. 6,532,857, entitled “Ceramic Array Armor,” discloses an elastomer encapsulated assembly containing shock isolated ceramic tiles, but does not disclose a simplified non-ceramic assembly design. The U.S. patent application Ser. No. 11/652,760, entitled, “Projectile Resistant Matrix for Manufacture for Manufacture of Projectile Resistant Trauma Shields,” discloses resin encapsulated trauma shield assemblies using a fiber matrix as a base, however, the design requires use of either ceramic or metal plates as part of the overall assembly that causes weight concerns.

In light of the current state of the art and the drawbacks to current anti-ballistic armor trauma plates mentioned above, a need exists for projectile resistant armor trauma shields without metal or ceramic plates and manufacture thereof that would be cost effective and light without degradation of protection against various threat levels.

### BRIEF SUMMARY OF THE INVENTION

The present invention discloses a method of producing and application for a projectile resistant matrix that allows for manufacture of low weight projectile resistant armor trauma shields that eliminates then need for metal or ceramic plates while still using projectile resistant textiles encapsulated in a composite matrix through use of injection molding process or spray on technique as constituents of the armor trauma shield without metal or ceramic plates of the present invention.

One aspect of the present invention provides a method for manufacture of projectile resistant armor trauma shields without metal or ceramic plates, comprising:
providing a mold configured to a body part for injection molding a projectile resistant armor trauma shield;
providing one or more layers of projectile resistant textile;
placing the projectile resistant matrix into the mold;
injection molding a first fluid precursor into the mold that forms into first elastomer for encapsulating the projectile resistant matrix, forming the projectile resistant armor trauma shield.
one optional aspect of the present invention provide a method for manufacture of projectile resistant armor trauma shields without metal or ceramic plates, wherein:
the mold is comprised of a top piece and a bottom piece, with the projectile resistant matrix inserted within the mold in between the top piece and the bottom piece and held with stand-off spacers, with the top and the bottom pieces of the mold closed for injection of the first fluid precursor therein by a high pressure fluid precursor dispensing equipment, encapsulating the projectile resistant matrix therein.

Still a further optional aspect of the present invention provides for a method for manufacture of projectile resistant armor trauma shields without metal or ceramic plates, wherein:
the adhesive of each individual layer of the multi-layer projectile resistant textile included is a glue.

Another optional aspect of the present invention provides for a method for manufacture of projectile resistant armor trauma shields without metal or ceramic plates, wherein:
the one or more layers of projectile resistant textile are comprised of aramid fabric or fibers.

A further optional aspect of the present invention provides for a method for manufacture of projectile resistant armor trauma shields without metal or ceramic plates, wherein:
at least one of the one or more layers of projectile resistant textile is comprised of synthetic form of natural fiber.

One aspect of the present invention provides a projectile resistant armor trauma shield, comprising:
one or more layers of projectile resistant textile;
an adhesive layer as a second fluid precursor that crosslink's under ambient conditions to form a second elastomer for coupling the one or more layers of the projectile resistant textile without metal or ceramic plates to form a projectile resistant matrix;
an encapsulation layer as a third fluid precursor that crosslink's under ambient conditions to form a third elastomer, which adheres to all surface areas of the projectile resistant matrix to a thickness to encapsulate the projectile resistant matrix.

One aspect of the present invention provides a projectile resistant armor trauma shield, comprising:
multiple layers of projectile resistant textile;
the multiple layers of projectile resistant textile are formed and held together using an application of high pressure compression;
an encapsulation layer as a third fluid precursor that crosslink's under ambient conditions to form a third elastomer, which adheres to all surface areas of the projectile resistant matrix to a thickness to encapsulate the projectile resistant matrix.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1A is an exemplary front perspective illustration of a non-limiting exemplary article of clothing, a non-limiting example of which is shown as an exemplary vest, with an associated set of a front and a side projectile resistant armor trauma shields without metal or ceramic plates in accordance with the present invention;

FIG. 1B is an exemplary perspective illustration of the vest shown in FIG. 1A, with the front and the side projectile resistant armor trauma shields without metal or ceramic plates being inserted into exemplary vest pockets;

FIG. 2A is an exemplary front perspective illustration of an exemplary projectile resistant armor trauma shield without metal or ceramic plates used for protection against a threat level from a projectile for the chest area of a human in accordance with the present invention;

FIG. 2B is an exemplary illustration of the back section of the projectile resistant armor trauma shield without metal or ceramic plates illustrated in FIG. 2A;

FIG. 3 is an exemplary illustration of the front view of the projectile resistant armor trauma shield without metal or ceramic plates illustrated in FIGS. 1A to 2B, exemplarily illustrating the constituents of the projectile resistant matrix used to manufacture the projectile resistant trauma shield without metal or ceramic plates in accordance with the present invention;

FIG. 4A is an exemplary perspective illustration of a mold configured to a body part for injection molding an elastomer for covering a projectile resistant matrix;

FIG. 4B is an exemplary perspective illustration of the mold illustrated in FIG. 4A, with the top and the bottom piece of the mold in proximity to one another;

FIG. 4C is an exemplary perspective illustration of the mold illustrated in FIG. 4B, with the mold connected to an injection head of a plural component high-pressure elastomer injection dispensing equipment in accordance with the present invention;

FIG. 5 is an exemplary illustration of a manufacturing technique for the spray-on application of the encapsulation onto the projectile resistant matrix in accordance with the present invention; and

### DETAILED DESCRIPTION OF THE INVENTION

The detailed description set forth below in connection with the appended drawings is intended as a description of presently non-limiting, exemplary, preferred embodiments of the invention and is not intended to represent the only forms in which the present invention may be constructed and or utilized.

References to a body are meant as a non-limiting, illustrative embodiment and for convenience of example. The term body used throughout the disclosure has been specifically defined below.

For the sake of convenience and clarity, this disclosure refers throughout to the term body as the physical structure and material substance of a human, animal or a plant. The present invention provides a projectile resistant matrix and a method for application thereof for manufacture of projectile resistant armor trauma shields without metal or ceramic plates. The present invention is a composite matrix and method of application of the matrix to provide projectile resistant armor trauma shields without metal or ceramic plates that provides protection against various threat levels from different projectiles.

The present invention overcomes the disadvantages of the prior art by providing a much lighter weight, non-brittle projectile resistant armor utility trauma shield without metal or ceramic plates assembly with the ability to withstand multiple projectile threats. The shield assembly of the present invention can be contoured for comfort for variable positional uses as desired. The shield assembly can be placed in a carry case or attached in numerous ways with a carrying case, harness holder, etc. using most items, non-limiting examples of which are straps, belts, snaps, Velcro etc. In addition, the shield assembly of the present invention can be inserted into pockets of any existing vest, coat, jacket, harness, uniform or other like items. Furthermore, it can also be integrated and designed to fit into the side of a vest, coat, jacket, harness, uniform or other like items as well as the front or back areas as required to compensate for area of vulnerability. The assembly is an integrated combination comprising of layers of projectile resistant fibers without the requirement of being affixed between one or more metal (or ceramic) plates. The fiber matrix assembly is formed, held together and strengthened through use of a variety of high pressure compression techniques used to compress the fiber matrix into a stronger pre-formed sub-assembly before it is encapsulated in a polymer resin layer through the use of an injection mold process and/or other related processes into the final trauma shield. This allows for better projectile resistance performance of the trauma shield without metal or ceramic plates with a lighter weigh ratio than those previous shields using metal or ceramic plates. In addition, the polymer resign can be impregnated before or after application with various material, non-limiting examples of which may include fibers (e.g., Dyneema®, Spectra Shield®, Kevlar®), aramid fiber composites, Teflon fibers, boron composites, unidirectional fiber composite materials, vulcanized urethane 3000 denier aramid composites, and unidirectional fiber/flexible resin composites.

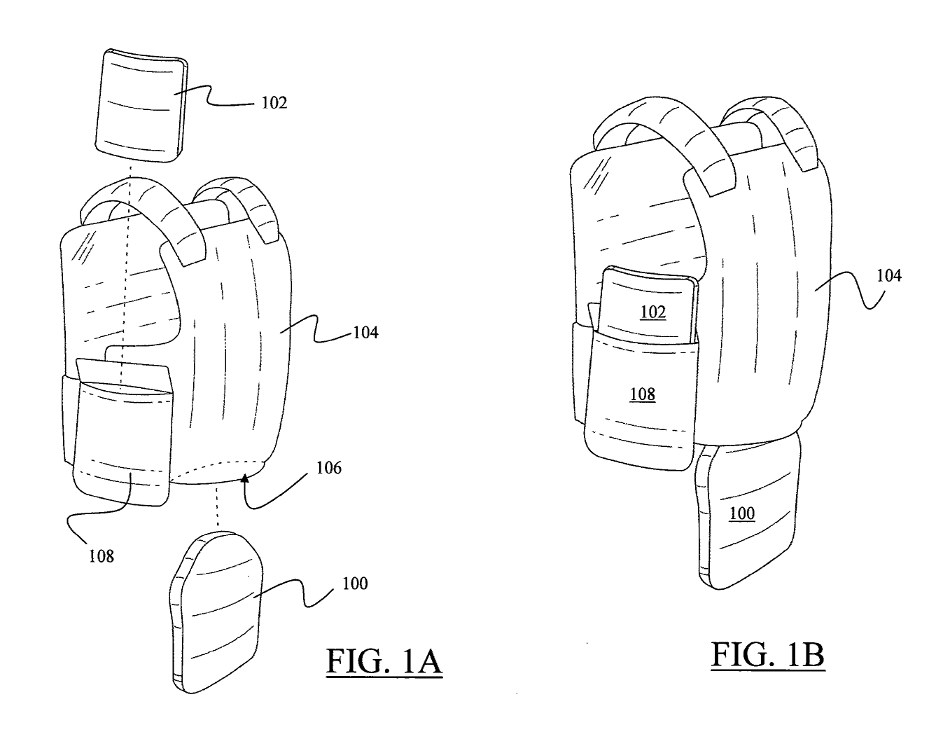

FIG. 1A is an exemplary front perspective illustration of a non-limiting exemplary article of clothing, a non-limiting example of which is shown as an exemplary vest, with an associated set of a front and a lateral projectile resistant armor trauma shields without metal or ceramic plates in accordance with the present invention. FIG. 1B is an exemplary perspective illustration of the vest shown in FIG. 1A, with the front and the side projectile resistant armor trauma shields without metal or ceramic plates being inserted into the exemplary vest pockets. As illustrated in both FIGS. 1A and 1B, the projectile resistant armor trauma shields without metal or ceramic plates 100 and 102 may be contoured to any size and shape and coupled with an article as described above. In this exemplary instance, frontal projectile resistant armor trauma shield without metal or ceramic plates 100 is inserted within the front section of the vest 104 via a front-bottom opening 106, and the lateral projectile resistant armor trauma shield without metal or ceramic plates 102 is inserted within a side pocket 108 of the vest 104. The frontal projectile resistant armor trauma shield without metal or ceramic plates 100 will provide protection against threat level from a projectile for the upper body, in particular the chest and abdomen, with the lateral projectile resistant armor trauma shield without metal or ceramic plates 102 providing protection against threat level from a projectile for the sides of the body. Although not illustrated, vests used for animals such as police dogs may also be adapted to carry projectile resistant armor trauma shields without metal or ceramic plates of the present invention, which can easily be contoured for animal use to provide protection against threat level from a projectile. A pocket or a vest is not necessary for the use of the projectile resistant armor trauma shields without metal or ceramic plates of the present invention. Any means to couple the shields with proximal area of a body to be protected, a few non-limiting examples of which are belts, straps, snaps, Velcro etc may be used.

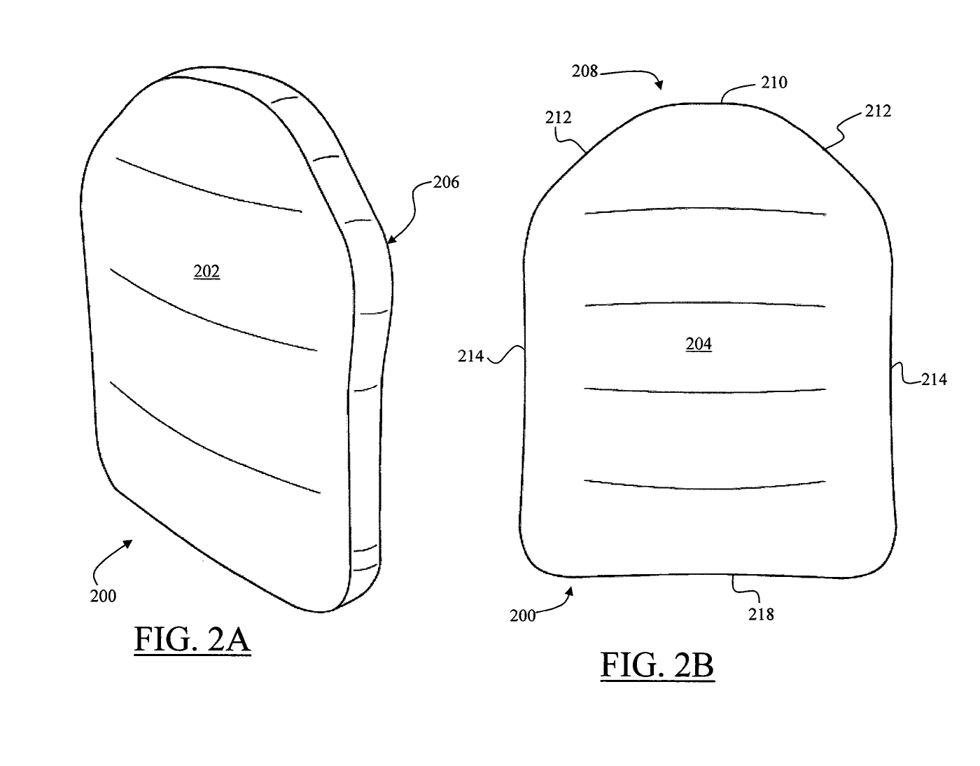

FIG. 2A is an exemplary front perspective illustration of an exemplary projectile resistant armor trauma shield without metal or ceramic plates in accordance with the present invention, and FIG. 2B is an exemplary illustration of the back side thereof illustrated in FIG. 2A. As illustrated in FIGS. 2A and 2B and described above, the projectile resistant armor trauma shield without metal or ceramic plates 200 may be contoured to any size and shape to meet the protection requirements for any body part. In this exemplary instance, the projectile resistant armor trauma shield without metal or ceramic plates 200 is exemplarily contoured to be used for protecting the human chest and abdomen. As illustrated, the front 202 of the projectile resistant armor trauma shield without metal or ceramic plates 200 is convex and the back 204 is concave, providing a form-factor for the projectile resistant armor trauma shield without metal or ceramic plates 200 that is commensurate with the curvature of the chest and abdomen areas of a human for a comfortable fit. The projectile resistant armor trauma shield without metal or ceramic plates 200 spans transverse the chest and the entire abdomen of the human, laterally covering the entire user front section. The size and shape of the projectile resistant armor trauma shield without metal or ceramic plates 200 can easily be varied to accommodate different users' sizes for an appropriate fit and effective protection.

The lateral walls 206, which constitute the thickness of the projectile resistant armor trauma shield without metal or ceramic plates 200, include a top section 208 that are substantially crescent (or arched) for a comfortable fit to allow for a free arm motion, especially near the shoulders, allowing the arms to move freely without coming into contact with the projectile resistant armor trauma shield without metal or ceramic plates 200. The arched or the crescent section is comprised of a fairly flat portion 210 followed by two oppositely curving, substantially diagonal portions 212. The side portions 214 of the lateral walls 206 are rather incurvate to allow free arm movement passing the body without coming into contact with the projectile resistant armor trauma shield without metal or ceramic plates 200. The bottom section 218 may be slightly curved as illustrated.

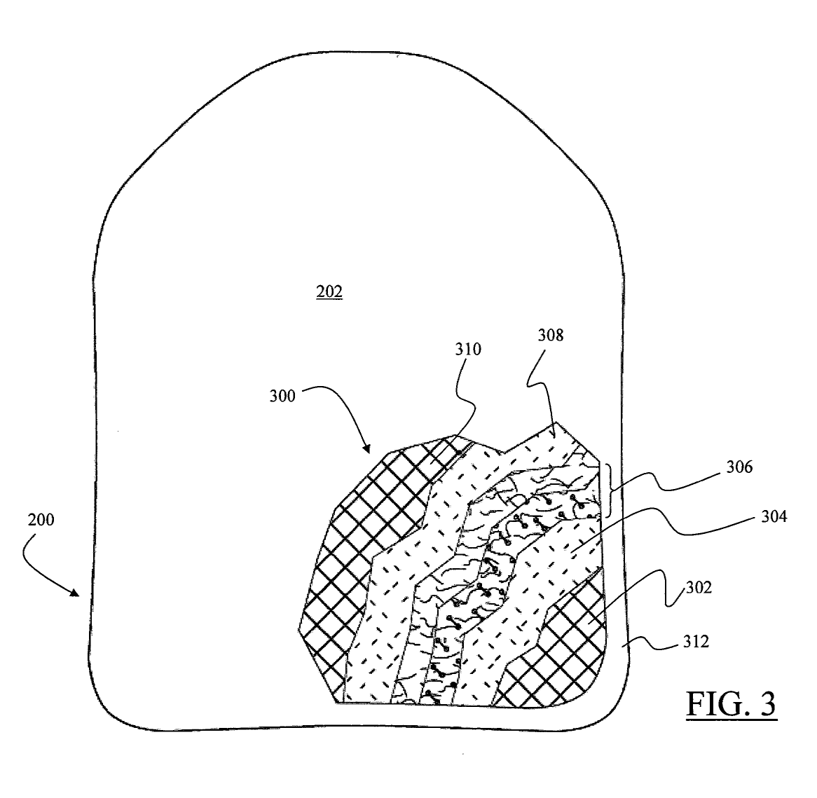

FIG. 3 is an exemplary illustration of the front view of the projectile resistant armor trauma shield without metal or ceramic plates illustrated in FIGS. 1A to 2B, showing the exemplary constituents of the projectile resistant matrix used to manufacture the projectile resistant armor trauma shield without metal or ceramic plates in accordance with the present invention. As illustrated in FIG. 3, the projectile resistant armor trauma shield without metal or ceramic plates 200 is comprised of an exemplary projectile resistant matrix 300 encapsulated within an elastormer 312. The first (or top) layer of the projectile resistant matrix 300 is a projectile resistant textile 302, which is furthest from the body, with the remaining layers layered behind this first layer 302. The projectile resistant matrix 300 includes the one or more layers of projectile resistant textile for example 302, 306 and 310 (or all layers made up of the same material). The one or more layers of the projectile resistant textile 302, 306 and/or 310 can be coupled and bonded together by a method applying high pressure compression to the multiple layers of projectile resistant materials (such as Dyneema®) and then combined by adhesive layers 304 and 308 to form the projectile resistant matrix 300. Injection molding techniques are then used to encapsulate the projectile resistant matrix 300 by the elastomer 312, forming the projectile resistant armor trauma shield without metal or ceramic plates 200.

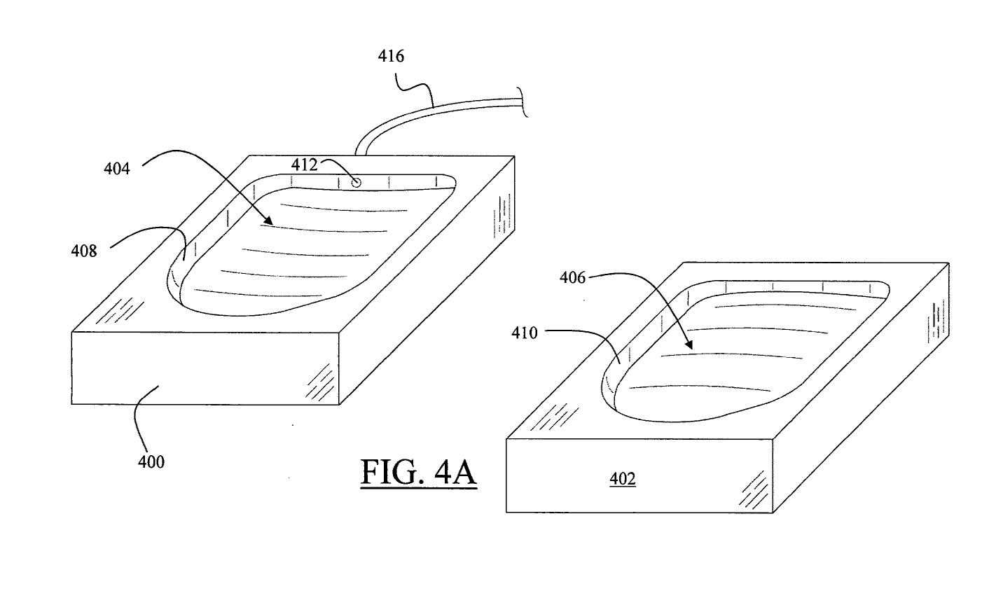

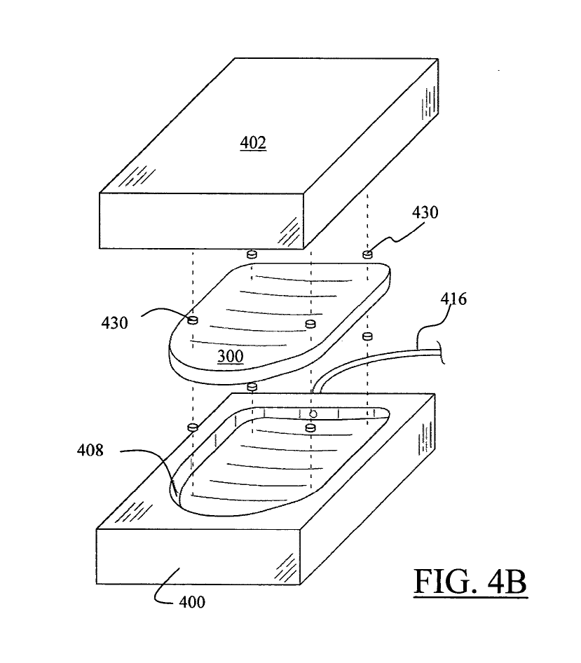

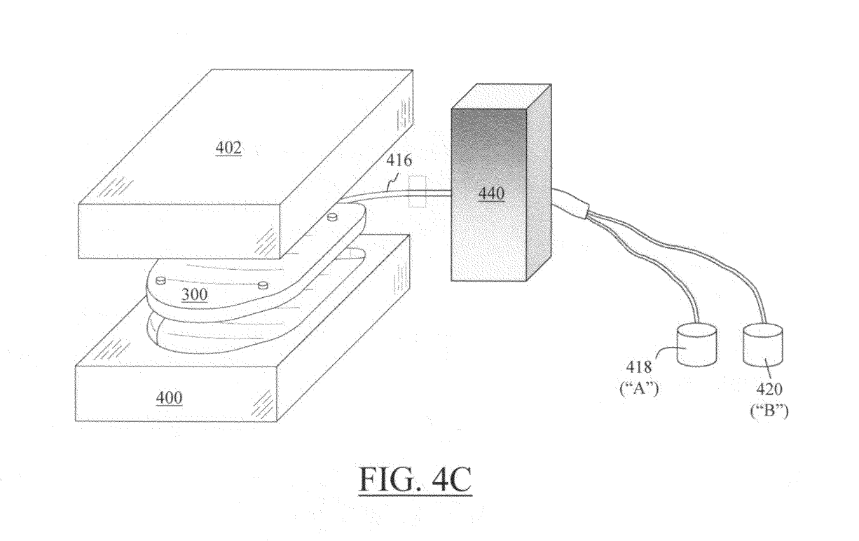

As illustrated in FIGS. 4A and 4B, the RIM molds include the bottom piece 400 having a bottom piece cavity 404 and a top piece 402 with a top piece cavity 406. The respective bottom and top piece cavities 404 and 406 are configured to mold any size and shape projectile resistant armor trauma shield without metal or ceramic plates 200 to meet the protection requirements for any body part. In this exemplary instance, the mold cavities 404 and 406 are commensurately contoured for manufacture of projectile resistant armor trauma shields without metal or ceramic plates 200 used for protecting the human chest and the abdomen. As illustrated, in this exemplary instance, the bottom piece cavity 404 has the negative form-factor of the front side 202 of the projectile resistant armor trauma shields without metal or ceramic plates 200, and the top piece cavity 406 has the negative form-factor of the backside 204. Therefore, in order to provide a convex shape for the front side 202, the bottom piece cavity 404 is incurvate (or concaved). Further, in order to provide a concave (incurvate) construction for the backside 204, the top piece cavity 406 has convex form-factor. Both cavities have interior surrounding walls 408 and 410, configured to form the lateral walls 206 of the projectile resistant armor trauma shields without metal or ceramic plates 200.

As best illustrated FIG. 4B, the projectile resistant matrix 300 is placed in between the respective top and bottom pieces 402 and 400. However, prior to the placement of the projectile resistant matrix 300 within the mold, a mold release agent is applied on an interior of the respective top and bottom pieces 402 and 400 of the mold to facilitate removal of the projectile resistant armor trauma shield without metal or ceramic plates 200 from the mold. A preferred mold release agent used is silicon-based, but any mold release agent may be used so long as it facilitates the release of the projectile resistant armor trauma shield without metal or ceramic plates 200 from the molds. After the application of the mold release agent, the projectile resistant matrix 300 is inserted and placed within the mold in between the top piece 402 and the bottom piece 404 and held with spacers 430. The spacers 430 center the projectile resistant matrix 300 within and between the mold cavities 404 and 406. The dimension of the spacers 430 used determines the desired thickness of the finished elastomer 312 that encapsulates the projectile resistant matrix 300. In general, the spacers 430 are comprised of prefabricated material that is comprised of the same material as the elastomer (the encapsulating cover 312). Although a total of eight spacers 430 are exemplarily illustrated, the number, shape, and sizes of the spacers 430 used can vary, and depends on the form-factor of the projectile resistant matrix 300, and the final resulting projectile resistant armor trauma shield without metal or ceramic plates 200. For the exemplary projectile resistant armor trauma shield without metal or ceramic plates 200, eight spacers 430 are used, with four on top, and four on the bottom, covering all corners as illustrated. The respective top and the bottom pieces 402 and 400 of the mold are then closed, ready for injection of the elastomer 312 therein by a high pressure fluid precursor dispensing equipment, encapsulating the projectile resistant matrix 300 therein.

FIG. 4C is an exemplary perspective illustration of the mold illustrated in FIG. 4B, with the mold connected to an injection head of a plural component high-pressure elastomer injection type dispensing equipment (hereinafter referred to as “injection machine 440”). After the closure of the respective top and bottom pieces 402 and 400 of the mold, the injection head of the injection machine 440 is coupled with the mold, and a measured amount of first type of elastomer is injected into the mold via a mold injection aperture 412 (FIGS. 4A and 4B). In general, the injection lasts an approximate two seconds, with the material temperature at an approximate range of about 110° F. to approximate 130° F. The elastomer injected is a first fluid precursor, which is a two-component formulation that reacts upon mixing to become the first elastomer 312 with a preliminary cure time. After the cure time, the molds are separated, and the finished armor trauma shield without metal or ceramic plates is removed.

The first type of polymer resin (a Polyurea) that forms the encapsulating layer 312 may comprise equal parts of an isocyanate and amine-terminated resin, which when combined comprises a first type of Polyurea. The first type of polymer resin (the elastomer) is injection molded in the form of a first fluid precursor that crosslink's (cures) under ambient conditions to form a solid rubbery layer that adheres strongly to the projectile resistant matrix 300 within the mold, forming into Polyurea encapsulating or covering layer 312.

The selected first type of elastomer is preferably one that cures without addition of heat and without evolving solvent vapors. Generally, elastomers that cure within these limitations are two-component systems “A” and “B,” that is, cross-linking results from reaction between two different chemical components, the “A,” which is the isocyanate and the “B,” which is the amine-terminated resin. Both components may end up as part of the elastomer, or one component may act as a catalyst to enable the other component to react within itself to form crosslink's, which solidify the fluid into a solid.

In particular, after preparing the composite (the part A and part B) of the first fluid precursor for injection of the encapsulating elastormer or Polyurea 312, the injection machine 440 used must be set to specified temperature ranges, depending on material in use, the weather conditions, and etc. In general, the hoses 416 are pre-heated for approximately 20 to 30 minutes before the main heat exchangers for the “A & B” materials is activated, and the part “B” side of the composite is pre-mixed for approximately 30 minutes, at minimum.

One preferred first type elastomer is a first type of Polyurea 312, preferably injected into the mold as a two-part mix. The injection machine 440 mixes the two components 418 and 420 often called Part A and Part B, in the correct stoichiometric ratio so that Part A 418 and Part B 420 mix and begin to cure into a rubbery solid immediately.

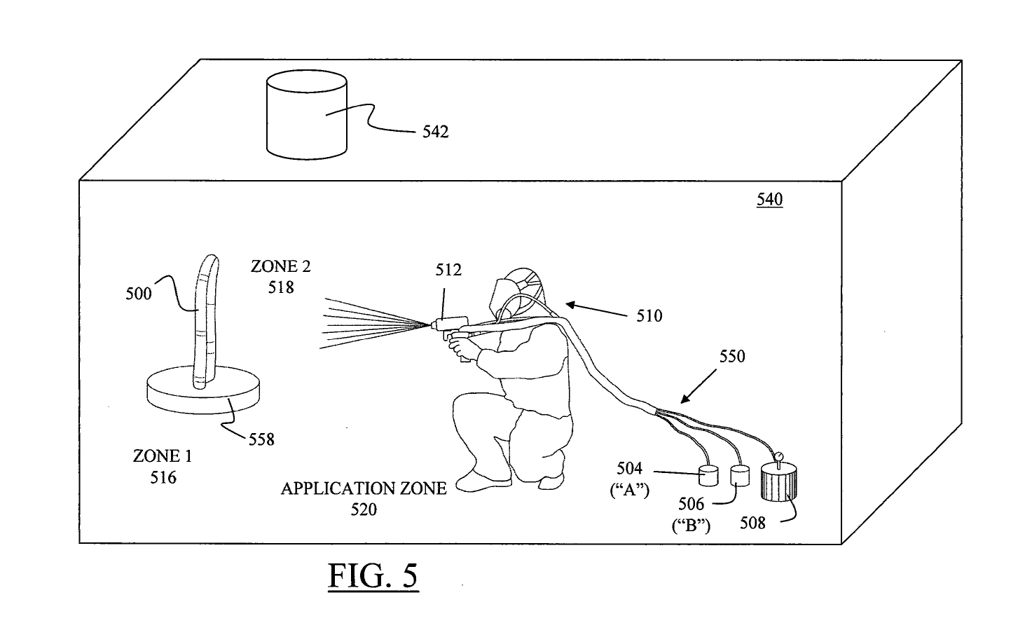

FIG. 5 is an exemplary illustration of another embodiment for a method for manufacture of projectile resistant armor trauma shields without metal or ceramic plates, using a spray-on application of another type of elastormer for encapsulation in accordance with the present invention. FIG. 5 is also an exemplary illustration of a manufacturing technique for the spray-on application of the encapsulation component (a third type of elastomer) onto the projectile resistant matrix. As illustrated, it is best to spray the second and the third types of polymer resins within a booth or closed area 540 that also includes an exhaust system 542 for safety. As illustrated in the FIG. 5, the encapsulating (third type of) elastormer 560 is directly sprayed onto the surface area of the projectile resistant matrix 502 using the spray-mixing gun 512.

The third type of polymer resin (a third type of Polyurea) that forms the encapsulation covering 560 may comprise equal parts of an isocyanate and amine-terminated resin, which when combined comprises the third type of Polyurea. The third type of polymer resin (the third type of elastomer) is sprayed-on in the form of a third type of fluid precursor that crosslink's (cures) under ambient conditions to form a solid rubbery layer that adheres strongly to the projectile resistant matrix 502, forming into Polyurea.

As with the second type of elastomer, the selected third type of elastomer is preferably one that cures without addition of heat and without evolving solvent vapors, so that it can be applied in an inhabited room 540. Generally, elastomers that cure within these limitations are two-component systems “A” and “B,” that is, cross linking results from reaction between two different chemical components, the “A,” which is the isocyanate and the “B,” which is the amine-terminated resin. Both components may end up as part of the elastomer, or one component may act as a catalyst to enable the other component to react within itself to form crosslink's, which solidify the fluid into a solid.

One preferred third type elastomer is a third type of Polyurea, preferably sprayed on as a two-part mix. The spray-mixing gun 512 mixes the two components 504 and 506 often called Part A and Part B, in the correct stoichiometric ratio so that Part A 504 and Part B 506 mix in flight and begin to cure into a rubbery solid immediately.

The third type of mixed precursor is fluid for a short time, then becomes a gel as crosslink's start to form. A gel does not run or slump, but is plastically deformed by small forces. After all available crosslink's have formed, third type of Polyurea is cured and considered a solid, although it is rubbery. A preferred, non-limiting exemplary formulation of the third type of elastomer that encapsulates the projectile resistant matrix 502 using the spray-on application technique.

In general, as illustrated in FIG. 5, the final encapsulating layer 560 of the third type of Polyurea is sprayed from the application zone 520 facing in the direction of the exhaust 542 and in front and center of the projectile resistant matrix 502. The spray-mixing gun 512 is aimed at zone 1, 516 bottom-left corner away from the user. The spray towards the projectile resistant matrix 502 is in sweeping passes in an up to down motion overlapping each pass and working towards zone 2, 518, finishing the spray of the third type of elastomer at zone 2, 518. The gun is then aimed at zone 1, 516 top left corner, but the spraying action is in a lateral (side-to-side) motion from zone 1, 516 to zone 2, 518, from top to bottom. In general, the spraying is repeated (up and down and laterally) while the projectile resistant matrix is rotated on a base unit 558 until a desired thickness for the encapsulation reached. It should be noted that the projectile resistant matrix can be facing the sprayer horizontally or vertically.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. For example, many combinations and permutations of the various layers constituting the projectile resistant matrices described is possible, including different layer arrangements. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A method for manufacture of projectile resistant armor trauma shields without metal or ceramic plates, comprising:
providing a mold configured to a body part for injection molding a projectile resistant armor trauma shield;
providing one or more layers of projectile resistant textile;
placing the projectile resistant matrix into the mold;
injection molding a first fluid precursor into the mold that forms into first elastomer for encapsulating the projectile resistant matrix, forming the projectile resistant armor trauma shield.

2. The method for manufacture of projectile resistant armor trauma shields without metal or ceramic plates as set forth in claim 1, wherein:
the mold is comprised of a top piece and a bottom piece, with the projectile resistant matrix inserted within the mold in between the top piece and the bottom piece and held with stand-off spacers, with the top and the bottom pieces of the mold closed for injection of the first fluid precursor therein by a high pressure fluid precursor dispensing equipment, encapsulating the projectile resistant matrix therein.

3. The method for manufacture of projectile resistant armor trauma shields as set forth in claim 1, wherein:
a mold release agent is applied on an interior of the top and bottom pieces of the mold to facilitate removal of the projectile resistant armor trauma shield from the mold.

4. The method for manufacture of projectile resistant armor trauma shields trauma shields without metal or ceramic plates as set forth in claim 1, wherein:
the multiple layers of projectile resistant textiles are combined and bonded using a method of high pressure compression to form the projectile resistant matrix.

5. The method for manufacture of projectile resistant armor trauma shields without metal or ceramic plates as set forth in claim 3, wherein:
the mold release agent is silicon-based mold release agent.

6. The method for manufacture of projectile resistant armor trauma shields without metal or ceramic plates as set forth in claim 1, wherein:
the one or more projectile resistant textile include:
determining a number of layers of projectile resistant textiles required for providing protection commensurate against a threat level;
dividing the determined number of layers of the projectile resistant textile into one or more groups of multi-layer projectile resistant textile; and
assembling each group of the one or more groups using adhesive to join one or more individual layers of the projectile resistant textile layer-by-layer to form the one or more groups of multi-layer projectile resistant textile.

7. The method for manufacture of projectile resistant armor trauma shields without metal or ceramic plates as set forth in claim 6, wherein:
the adhesive of each individual layer of the multi-layer projectile resistant textile included is activated upon application of heat.

8. The method for manufacture of projectile resistant armor trauma shields without metal or ceramic plates as set forth in claim 6, wherein:
the adhesive of each individual layer of the multi-layer projectile resistant textile included is a second elastomer.

9. The method for manufacture of projectile resistant armor trauma shields without metal or ceramic plates as set forth in claim 6, wherein:
the adhesive of each individual layer of the multi-layer projectile resistant textile included is a glue.

10. The method for manufacture of projectile resistant armor trauma shields without metal or ceramic plates as set forth in claim 1, wherein:
the one or more layers of projectile resistant textile are comprised of aramid fabric.

11. The method for manufacture of projectile resistant armor trauma shields without metal or ceramic plates as set forth in claim 1, wherein:
the one or more layers of projectile resistant textile are comprised of synthetic form of a natural fiber.

12. The method for manufacture of projectile resistant armor trauma shields without metal or ceramic plates as set forth in claim 1, wherein:
at least one of the one or more layers of projectile resistant textile is comprised of aramid fabric.

13. The method for manufacture of projectile resistant armor trauma shields without metal or ceramic plates as set forth in claim 1, wherein:
at least one of the one or more layers of projectile resistant textile is comprised of synthetic form of natural fiber.

14. The method for manufacture of projectile resistant armor trauma shields without metal or ceramic plates as set forth in claim 1, wherein:
at least one of the one or more layers of projectile resistant textile is comprised of aramid fabric and one other of the one or more layers of projectile resistant textile is comprised of synthetic form of natural fiber.

15. The method for manufacture of projectile resistant armor trauma shields without metal or ceramic plates as set forth in claim 1, wherein:
at least one layer of the one or more layers of the projectile resistant textile has a thickness of at least 0.61 mm to 6.0 mm.

16. A projectile resistant armor trauma shield with metal or ceramic plates, comprising:
one or more layers of projectile resistant textile;
an adhesive layer as a second fluid precursor that crosslink's under ambient conditions to form a second elastomer for coupling the one or more layers of the projectile resistant textile with the one or more layers of the plates to form a projectile resistant matrix;
an encapsulation layer as a third fluid precursor that crosslink's under ambient conditions to form a third elastomer, which adheres to all surface areas of the projectile resistant matrix to a thickness to encapsulate the projectile resistant matrix.
